(19) United States
(12) Patent Application Publication
(10) Pub. No.: US 2004/0172479 A1
(43) Pub. Date: Sep. 2, 2004

(54) Method for simultaneously operating at least two tunnels on at least a network

(76) Inventors: Vladimir Ksinant, Issy les Monlineaux (FR); Jeasn-Mickael Guerin, Issy les Monlineaux (FR)

Correspondence Address: William Anthony Drucker, Suite 800, 1901 L Street NW, Washington, DC, 20036-3506, US

(21) Appl. No.: 10/484,777

(22) PCT Filed: Jul. 9, 2002
(86) PCT No.: PCT/FR02/02398

(30) Foreign Application Priority Data
Jul. 23, 2001 (FR) 01/10043

(51) Int. Cl. G06F 15/16

(52) U.S. Cl. 709/236

(57) ABSTRACT

The invention concerns a method for simultaneously operating at least two tunnels on at least a network. It includes, at the intermediate node, a sequence comprising retrieving all the tunnel headers (step E₈) and, if required, reassembling the original packet from its fragments (step E₇), processing operations corresponding to one or more functions, performed on the original packet (step E₃), optionally fragmenting once more the packet which have been processed (step E₁₁) and restoring the headers of the tunnels (step E₁₄).

The subject of this present invention is a method and a system which allow simultaneous operation of multiple tunnels in which the data are transmitted in the form of packets obeying a first protocol and enclosed within packets created under at least one second protocol.

In particular, it concerns messages circulating in IP networks which use the Internet protocol, and which are composed of IP packets.

In general, it is known that the use of tunnels or “tunnelling” is a technique employed in a large number of now functions associated with networks. This technique consists of the following in particular:

causing a packet to be subjected, where appropriate, to a reversible conversion, and then

encapsulating the packet (converted, where appropriate) either at the source of the packet or at an intermediate node of the network.

The information concerning the operations (of fragmentation, encapsulation, etc.) undergone by the packet constitutes a context. In addition to the various fragments, the context is necessary in order to correctly reconstitute the packet as it was emitted by its source.

The tunnels are now used in Internet technologies in order to provide the following functions.

security, which consists of encrypting the packets in order to ensure the confidentiality of the data,

IPv4/IPv6 migration, which consists of allowing v4 and v6 access to IP networks,

emulation of private networks.

Of course, this list is not exhaustive and it is probable that new uses will appear in the future, given that various types of tunnels already coexist on the Internet. However, although the standards provide a good specification for each function taken separately, on the other hand they do not describe the interaction of the different functions within a network machine.

Furthermore, it turns out that it is sometimes difficult to simultaneously realise several functions if these functions all employ the tunnelling idea. In fact tunnels which are used simultaneously become superimposed. The packet is then encapsulated at the entrance to each tunnel.

The processing applied at an intermediate node of the network depends on information read from the header of the packet. When the original packet has traversed one or more tunnels, the new packet possesses several tunnel headers. It then has to wonder which processing it should apply.

Tunnelling also introduces the problem of packet length. In fact the packets are always of a maximum length, which is dependent on the technology of the subjacent link The maximum size of a packet is called the Maximum Transfer Unit (MTU). Each tunnel adds a header to the packet, and therefore alters its size. If this size becomes greater than the Maximum Transfer Unit (MTU), then it becomes necessary to fragment the packet again at the time of transmission, and to re-assemble it on reception.

More particularly, the aim of the invention is a process which allows the simultaneous operation of several functions which employ the notion of tunnelling, in spite of the constraints, mentioned above, to which this technique gives rise.

To this end, when all intermediate node of the network (which is a network machine) must execute one or more methods corresponding to one or more functions, the invention proposes to execute these methods on the packet as it was transmitted by the source and not on the packet (or its fragments) received by the node after passing through the various tunnels.

As a consequence, the method according to the invention comprises an operational sequence at the level of the intermediate node, which comprises the following steps.

the extraction of all tunnel headers (de-encapsulation of the original packet) and, if necessary, reassembly of the packet from its fragments (in the event that a packet has previously undergone fragmentation),

the processing associated with the functions on the original packet, and

refragmentation, where appropriate, of the packet which has been subjected to this processing, and reinsertion of the tunnel headers.

Where appropriate, during the extraction and reassembly steps, the above-mentioned method can comprise a step for the storage of contexts which comprise information concerning the operations (fragmentation and encapsulation) undergone by the packet. This information can then be re-used in the refragmentation step and in the reinsertion of tunnel headers.

This method is recursive. It applies not only to the intermediate nodes of the network but also to the host station, the source of the packet.

An important advantage of this method is that there is no constraint on the processing performed on the original packet.

As an example, these methods can consist of the creation of a new tunnel and/or operations concerning the differentiation of packets in order to guarantee quality of service. They can also be associated with other types of function.

Of course, the invention can also be implemented either by hardware or software.

One method of execution of the invention will be described below, with reference to the appended drawings in which;

FIG. 1 is a schematic representation which illustrates the tunnelling technique, comprising the optional reversible conversion and the encapsulation of the whole of a packet;

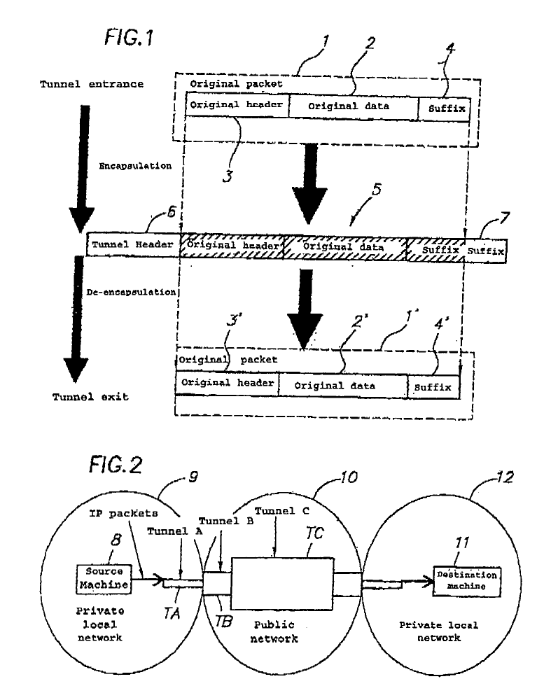

FIG. 2 is the schematic representation of the transmission of a packet, with passage through three tunnels;

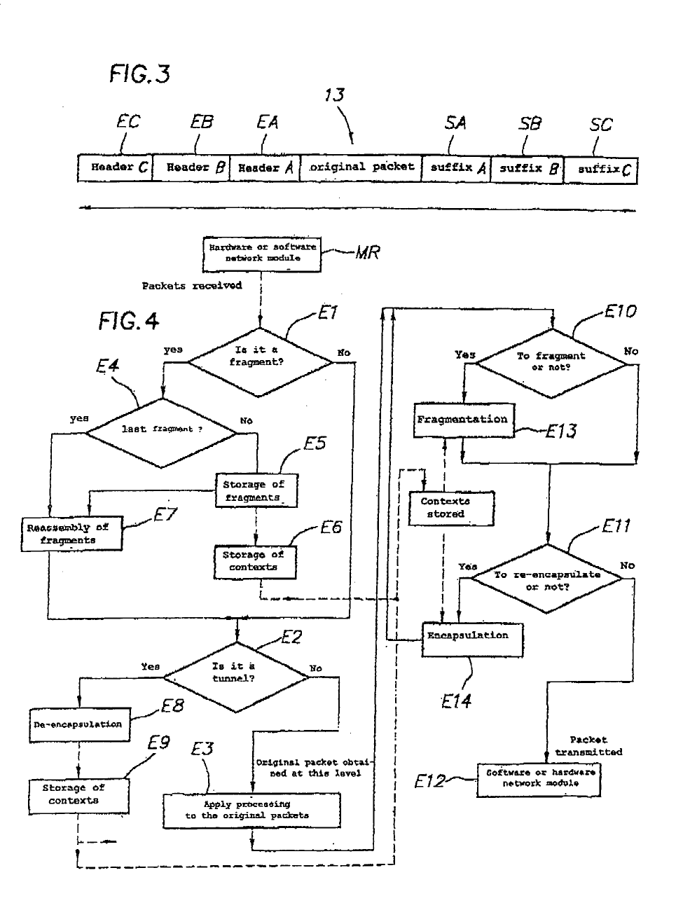

FIG. 3 shows the structure of a packet, obtained after passage through three tunnels using the conventional method;

FIG. 4 is an algorithm for implementation of the method according to the invention;

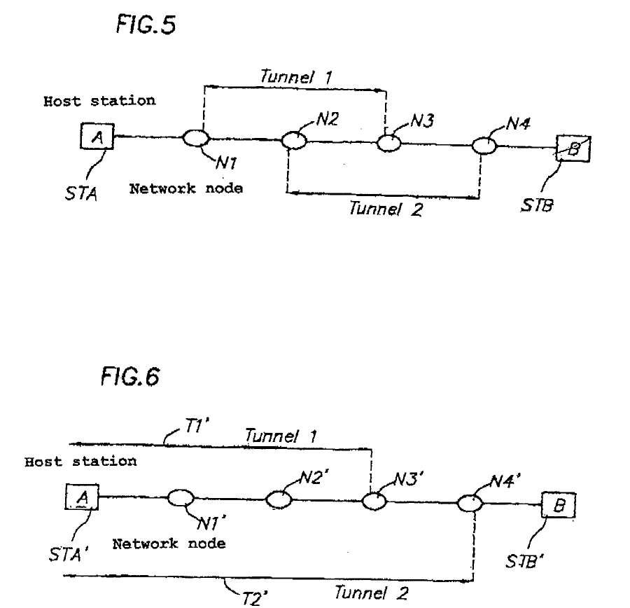

FIGS. 5 and 6 show two examples in which the tunnels are created, either from the host or at the nodes of the network.

As previously mentioned, the messages circulating in the networks, and particularly in IP networks (using the Internet protocol) are composed of packets.

As illustrated in FIG. 1, originally, each of these packets is composed of data of origin 2, preceded by a header of origin 3 and a suffix 4.

At the entrance to a tunnel, this packet of origin 1 undergoes encapsulation, which is a reversible method according to which the totality of packet 1 is included in a new packet 5, with a new header (tunnel header 6) and, if necessary, a new suffix (tunnel suffix 7), after undergoing an optional reversible conversion where appropriate.

Given the reversible character of the encapsulation, the encapsulated packet (5) can undergo a reverse de-encapsulation conversion in order to leave the tunnel, and restore the packet of origin 1′ (header of origin 3′, data of origin 2′, and suffixes 4′). This conversion comprises extraction of the capsule composed of tunnel header 6, and tunnel suffix 7 where appropriate.

FIG. 2 gives an example in which an IP packet emitted by a source machine (8) of a private local network (9) passes through three tunnels, TA, TB and TC, transited by a public network (10), before arriving at the destination machine (11) of a second public local network (12).

As an example, the first tunnel (TA) can consist of an encryption tunnel, tunnel TB is designed so as to traverse public network 10, which is different in nature from network 9, and tunnel TC is an IPv4/IPv6 migration tunnel.

FIG. 3 illustrates packet 13, having simultaneously traversed the three tunnels, TA, TB and TC, and therefore three successive encapsulations. This packet comprises the packet of origin preceded by three successive headers, namely, starting from the centre, header EA, header EB and header EC, and three successive suffixes, namely suffix SA, suffix SB, and suffix SC.

Of course, this example is not exhaustive, given that numerous other functions could be associated with the tunnels, and could be used in the same way.

As previously mentioned, the methods applied at the intermediate node of the public network depend on the information read from the packet header. Now in the case in hand, the packet of origin 14 has already passed through three tunnels and so has three headers, EA, EB and EC, in addition to the original header. The problem is then to know to which header the processing should be applied.

The invention proposes to perform these methods not on packet 13 (or its fragments) received by the intermediate node after passage through the various tunnels, but on the original packet 14 as it was emitted by the source.

This solution involves successive operations of de-encapsulation, reassembly where necessary, processing, refragmentation where necessary, and re-encapsulation.

This method can be executed by means of a hardware or software network module (MR) according to an algorithm as illustrated in FIG. 4, in which;

Each packet received by the network module (MR) is analysed so as to ascertain whether it was an original packet fragment or a non-fragmented packet (step E₁).

If it is an unfragmented packet, then the module detects whether or not this packet is a tunnel (step E₂).

If the packet is not a tunnel, it is therefore an original packet. As a consequence, the processing is applied to this original packet (step E₃).

In the event that the module detects a packet fragment at step E₁, it then ascertains if this fragment is the last fragment of a packet (step E₄). In this case, if it is not the last fragment, the module then proceeds to store the fragment in memory (step E₅), and to store the context relating to this fragment (step E₆).

In the event that it is a last fragment, the module then proceeds to re-assemble the fragments previously stored in memory (step E₇) in order to obtain a packet. The module then passes to step E₂ in order to ascertain whether or not the packet is a tunnel.

If the module detects a tunnel at step E₂, it then performs a de-encapsulation of this tunnel (step E₈), and then stores in memory the context relating to this tunnel (step E₉). The packet obtained after this de-encapsulation is then sent to step E₁ for detection of fragments before starting a fresh cycle.

Of course, if the module does not detect a tunnel in step E₂, the packet is then an original packet, and the module applies methods to this packet, such as optional reversible processing for example (step E₃).

The module then determines whether the original packet to which the processing was applied should be fragmented or not (step E₁₀). This determination takes account of the context stored in steps E₆ and E₉.

If the packet is not to be fragment, the module determines whether it should be re-encapsulated or not (step E₁₁). If not, then the packet can be transmitted on the network on which the module is located (step E₁₂).

Where the module determines at step E₁₀ that the packet should be fragmented, it then proceeds to fragment this packet (step E₁₃), taking account of the contexts stored at steps E₆ to E₉, and determines at step E₁₁ whether the fragments should be re-encapsulated or not.

If the module determines at step E₁₁ that the packet (or the fragment) is to be re-encapsulated, it then performs an encapsulation (step E₁₄) before determining whether the re-encapsulated packet should be fragmented or not (step E₁₀).

It should be noted here that, in this method, the term “context” concerns information relating to the operations (fragmentation, encapsulation) undergone by a packet. In addition to different packets, the context is necessary in order to reform the packet correctly, as it was emitted by the source.

Furthermore, the capsules and the contexts stored in steps E₆ and E₉, when the packets are de-encapsulated before processing is applied, contain, in particular, the headers and the suffixes of the packets as well as the length of the received packets.

An important advantage of the method described above is that it allows the simultaneous use and interoperation of the functions which create the tunnels.

These fractions can be created in routers or in host stations.

Using this method, interoperation of the functions associated with tunnels is guaranteed, since each function treats the original packet as if it were alone, that is independent of the other functions.

Thus, for example, this method is able to use the following functions simultaneously:

IPSEC security, which consists of encrypting the packets in order to ensure the confidentiality of the data,

IPv4/IPv6 migration, which consists of allowing access to versions v4 and v6 of the IP networks,

the quality of service (QoS), which consists of differentiating between IP packets, and regulating them, in order to optimise network traffic.

Of course, this method according to the invention can be extended to any tunnel-based function. It applies in particular to the creation of virtual, unsecured, private networks. In this case, it involves emulation of a local network (LAN) which covers a restricted area only, through a link with a global or wide-area network (WAN) with a large extension, and having connections, such as telephone connections, with the local network (LAN), as is the practice at present.

Another special feature of the method according to the invention is that the ends of each tunnel can be different, which has not been possible in the methods used in current tunnelling practice.

The examples illustrated in FIGS. 5 and 6 show tunnels which have been established either from a host station or at the nodes of the network.

In the example at FIG. 5, the network linking the host station (STA) to a second station (STB) comprises four nodes, N₁ to N₄, and two tunnels, T₁ and T₂. Tunnel T₁ links node N₁ to node N₃, while tunnel T₂ links node N₂ to node N₄.

In the example at FIG. 6, which shows network STA′, N′₁ to N′₄, STB′ similar to the previous one, tunnels T′₁ and T′₂ are established from host station STA′. Tunnel T′₁ ends in node N′₃ while tunnel T′₂ ends in node N′₄.

1. A method for the simultaneous operation of at least two tunnels in at least one network, on which the data are transmitted by a host station in the form of packets obeying a first protocol and enclosed within packets created under at least one second protocol,
characterised in that it comprises, at the level of the intermediate node, an operating sequence which comprises the following steps;
extraction of the tunnel headers so as to achieve a de-encapsulation of the original packet and, if necessary, reassembly of the original packet from its fragments in the case of an original packet which has been subjected to fragmentation,
processing which corresponds to one or more functions performed on the original packet,
re-fragmentation, where appropriate, of the packet which has undergone processing and restoration of tunnel headers.

2. A method according to claim 1,
characterised in that the aforementioned intermediate node is a software and/or hardware machine.

3. A method according to claims 1 and 2,
characterised in that it comprises, during the extraction and reassembly phases, a step for the storage of contexts, comprising information concerning the operations undergone by the packet, and in that it uses this information in the re-fragmentation phase and for restoration of the tunnel headers.

4. A method according to the previous claims,
characterised in that it is recursive, and that it applies not only to the intermediate nodes of the network but also to the host station, the source of the packet.

5. A method according to the previous claims,
characterised in that the aforementioned processing consists of the creation of new tunnels, and/or of operations concerning the differentiation of packets in order to ensure the quality of service.

6. A method according to the previous claims,
characterised in that it comprises an operational cycle which comprises the following steps:
a first analysis step to determine whether or not the packet received by the network module is a fragment,
a second detection step to determine whether or not the packet is a fragment, in the case of an unfragmented packet.
a third processing step in the event that the packet is not a tunnel.

7. A method according to claim 6,
characterised in that, in the event that a packet fragment is detected at the first step, it comprises the storage of the fragment in memory, as well as of the context relating to this fragment, and in that, when a last fragment is detected, it comprises reassembly of the previously stored fragments in order to obtain a packet which is successively processed in the second and third steps.

8. A method according to claim 6,
characterised in that, in the event that a tunnel is detected in the second step, it then proceeds to de-encapsulate this tunnel and to store in memory the context associated with this tunnel, and in that the packet obtained after de-encapsulation is then sent to the first step in order to undergo a fresh operational cycle.

9. A method according to claim 6,
characterised in that it comprises a fourth step for determination of whether or not the original packet to which the processing has been applied should be fragmented, where such determination takes account of the contexts stored in memory.

10. A method according to claim 9,
characterised in that it comprises a step for determining whether or not the packet which is not to be fragmented should be re-encapsulated, and in that if it is not to be re-encapsulated, it transmits the packet on the network, and if it is to be re-encapsulated, it comprises a re-encapsulation step before determining whether or not the re-encapsulated packet is to be fragmented.

11. A method according to claim 9,
characterised in that if the packet is to be fragmented, it then proceeds to fragment the packet, taking account of the contexts stored at steps E₆ and E₉, and determines whether or not the packets should be re-encapsulated, and in that if they are not to be re-encapsulated, it transmits the packets on the network, and if they are to be re-encapsulated, it comprises a re-encapsulation step before determining whether or not the re-encapsulated packet is to be fragmented.
